(19) United States
(12) Patent Application Publication
(10) Pub. No.: US 2008/0058080 A1
(43) Pub. Date: Mar. 6, 2008

(54) Slot machine game in which prize is awarded based on number of scatter colors displayed behind plurality of symbols

(75) Inventor: Kazumasa Yoshizawa, Tokyo (JP)

Correspondence Address: ARENT FOX LLP, 1050 CONNECTICUT AVENUE, N.W., SUITE 400, WASHINGTON, DC, 20036, US

(73) Assignee: ARUZE Corp

(21) Appl. No.: 11/878,931

(22) Filed: Jul. 27, 2007

(30) Foreign Application Priority Data
Aug. 7, 2006 (JP) 2006-214894

(51) Int. Cl. A63F 13/00

(52) U.S. Cl. 463/20; 463/16

(57) ABSTRACT

To increase an entertainment aspect of a slot machine, by endowing an “any” dividend with a diversity. By simultaneously revolving and sequentially stopping three video reels, a plurality of symbols disposed in display windows of a lower image display panel are redisposed. At this time, it may happen that a scatter color is displayed in any of specific areas, which are behind the redisposed symbols. Then, in the event that “ORANGE”, which is a scatter symbol, is included in the redisposed symbols, a number of combinations in which the scatter color is displayed behind “ORANGE” is counted. This count is carried out separately for each color of scatter color. Then, a predetermined dividend amount is awarded to a player, in accordance with the number counted, as an “any” dividend.

### RELATED APPLICATION

This application claims the priority of Japanese Patent Application No. 2006-214894 filed on Aug. 7, 2006, which is incorporated herein by reference.

### BACKGROUND OF THE INVENTION

1. Technical Field

The present invention relates to a slot machine which awards a prize based on a number of specific symbols redisposed and to a playing method of the slot machine.

2. Related Art

In a heretofore known slot machine, there is one which includes an “any” dividend, which awards prize money in accordance with a number of scatter symbols (for example, refer to U.S. Pat. No. 6,960,133 B1)

However, as a symbol used as the scatter symbol has been limited to a specific one kind, in order to avoid bother with the slot machine, a format of the “any” dividend has been constant.

### SUMMARY OF THE INVENTION

Therefore, the invention, being contrived bearing in mind the heretofore described point, has an object of increasing an entertainment aspect of a slot machine by endowing an “any” dividend with a diversity.

In a slot machine (for example, a slot machine 1) according to claim 1, a plurality of symbols disposed on a display (for example, display windows 10L, 10C and 10R in a lower image display panel 6) are redisposed.

A game controller (for example, a game controller 100), every time it executes the redisposition, decides whether or not to display a scatter color in any of specific areas (for example, Z1 to Z9) positioned one behind each of the plurality of symbols redisposed on the display (for example, S22).

Then, the game controller, when displaying the scatter color in any of the specific areas of the display, in accordance with details of the decision, when executing the redisposition, counts a number of the specific areas of the display in which the scatter color has been displayed (for example, S44).

Furthermore, the game controller awards a prize based on the number counted (for example, S46).

Also, a slot machine according to claim 2 being the slot machine according to claim 1, the game controller, when counting the number of the specific areas of the display in which the scatter color has been displayed, limits a subject of the count to specific areas of the display, among the specific areas of the display in which the scatter color has been displayed, in which a scatter symbol has been redisposed (for example, S45).

Also, a slot machine according to claim 3 being the slot machine according to claim 1, a plurality of kinds of scatter color are prepared.

Then, the game controller, when counting the number of the specific areas of the display in which the scatter color has been displayed, counts separately for each kind of scatter color.

Also, a slot machine according to claim 4 being the slot machine according to claim 1, the game controller, when displaying the scatter color in any of the specific areas of the display, displays the scatter color in the specific areas by means of a texture mapping which makes the specific areas of the display a textural surface (for example, S32). With the display, the game controller excepts the symbols positioned inside the relevant display areas from the textural surface.

In a slot machine (for example, the slot machine 1) according to claim 5, a plurality of symbols disposed on a display (for example, the display windows 10L, 10C and 10R in the lower image display panel 6) are redisposed.

A game controller (for example, the game controller 100), every time it executes the redisposition, decides whether or not to display a scatter color, a plurality of kinds of which have been prepared, in such a way as to include those colors, in any of specific areas (for example, Z1 to Z9) positioned one behind each of the plurality of symbols redisposed on the display (for example, S22).

Then, the game controller, when displaying the scatter color in any of the specific areas of the display, in accordance with details of the decision, when executing the redisposition, counts a number of the specific areas of the display in which the scatter color has been displayed separately for each kind of scatter color (for example, S44).

At this time, the game controller limits a subject when making the count to specific areas of the display, among the specific areas of the display in which the scatter color has been displayed, in which a scatter symbol has been redisposed (for example, S45).

Furthermore, the game controller awards a prize based on the number counted (for example, S46).

Also, in a slot machine (for example, the slot machine 1) according to claim 6, a plurality of symbols disposed on a display (for example, the display windows 10L, 10C and 10R in the lower image display panel 6) are redisposed.

A game controller (for example, the game controller 100), every time it executes the redisposition of the plurality of symbols redisposed on the display, decides whether or not to display a scatter color in any of specific areas (for example, Z1 to Z9) positioned one behind each of the plurality of symbols redisposed on the display.

Then, the game controller, when displaying the scatter color in any of the specific areas of the display, in accordance with details of the decision, when executing the redisposition, displays the scatter color in the specific areas by means of a texture mapping which makes the specific areas of the display a textural surface (for example, S32). With the display, the game controller excepts the symbols positioned inside the relevant display areas from the textural surface.

Furthermore, the game controller counts a number of the specific areas of the display in which the scatter color has been displayed (for example, S44).

At this time, the game controller limits a subject when making the count to specific areas of the display, among the specific areas of the display in which the scatter color has been displayed, in which a scatter symbol has been redisposed (for example, S45).

Furthermore, the game controller and awards a prize based on the number counted (for example, S46).

Also, in a slot machine (for example, the slot machine 1) according to claim 7, a plurality of symbols disposed on a display (for example, the display windows 10L, 10C and 10R in the lower image display panel 6) are redisposed.

A game controller (for example, the game controller 100), every time it executes the redisposition, decides whether or not to display a scatter color, a plurality of kinds of which have been prepared, in such a way as to include those colors, in any of specific areas (for example, Z1 to Z9) positioned one behind each of the plurality of symbols redisposed on the display (for example, S22).

Then, the game controller, when displaying the scatter color in any of the specific areas of the display, in accordance with details of the decision, when executing the redisposition, displays the scatter color in the specific areas by means of a texture mapping which makes the specific areas of the display a textural surface (for example, S32). With the display, the game controller excepts the symbols positioned inside the relevant display areas from the textural surface.

Furthermore, the game controller counts a number of the specific areas of the display in which the scatter color has been displayed separately for each kind of scatter color (for example, S44).

Furthermore, the game controller awards a prize based on the number counted (for example, S46).

Also, in a slot machine (for example, the slot machine 1) according to claim 8, a plurality of symbols disposed on a display (for example, the display windows 10L, 10C and 10R in the lower image display panel 6) are redisposed.

A game controller (for example, the game controller 100), every time it executes the redisposition of the plurality of symbols redisposed on the display, decides whether or not to display a scatter color, a plurality of kinds of which have been prepared, in such a way as to include those colors, in any of specific areas (for example, Z1 to Z9) positioned one behind each of the plurality of symbols redisposed on the display (for example, S22).

Then, the game controller, when displaying the scatter color in any of the specific areas of the display, in accordance with details of the decision, when executing the redisposition, displays the scatter color in the specific areas by means of a texture mapping which makes the specific areas of the display a textural surface (for example, S32). With the display, the game controller excepts the symbols positioned inside the relevant display areas from the textural surface.

Furthermore, the game controller counts a number of the specific areas of the display in which the scatter color has been displayed separately for each kind of scatter color (for example, S44).

At this time, the game controller limits a subject when making the count to specific areas of the display, among the specific areas of the display in which the scatter color has been displayed, in which a scatter symbol has been redisposed (for example, S45).

Furthermore, the game controller awards a prize based on the number counted (for example, S46).

Also, in a slot machine (for example, the slot machine 1) playing method according to claim 9, a unit game, in which a redisposition of a plurality of symbols disposed on a display (for example, the display windows 10L, 10C and 10R in the lower image display panel 6) is performed, is repeated by a game controller (for example, the game controller 100).

At this time, every time the game controller executes the predisposition, the game controller decides whether or not to display a scatter color in any of specific areas (for example, Z1 to Z9) positioned one behind each of the plurality of symbols redisposed on the display (for example, S22).

Then, when the game controller executes the redisposition, when the game controller displays the scatter color in any of the specific areas of the display, in accordance with details of the decision, the game controller counts a number of the specific areas of the display in which the scatter color has been displayed (for example, S44).

Furthermore, the game controller awards a prize based on the number counted (for example, S46).

Also, a slot machine (for example, the slot machine 1) playing method according to claim 10 being the slot machine playing method according to claim 9, when the game controller counts the number of the specific areas of the display in which the scatter color has been displayed, the game controller limits a subject of the count to specific areas of the display, among the specific areas of the display in which the scatter color has been displayed, in which a scatter symbol has been redisposed (for example, S45).

Also, a slot machine (for example, the slot machine 1) playing method according to claim 11 being the slot machine playing method according to claim 9, at the stage in which the game controller decides whether or not the game controller displays the scatter color in any of the specific areas positioned one behind each of the plurality of symbols redisposed on the display (for example, S22), the game controller decides whether or not the game controller displays the scatter color, a plurality of kinds of which have been prepared, in such a way as to include those colors, in any of the specific areas positioned one behind each of the plurality of symbols redisposed on the display.

Also, at the stage in which the game controller counts the number of the specific areas of the display in which the scatter color has been displayed (for example, S44), the game controller counts the number of the specific areas of the display in which the scatter color has been displayed separately for each kind of scatter color.

Also, a slot machine (for example, the slot machine 1) playing method according to claim 12 being the slot machine playing method according to claim 9, at the stage at which the game controller displays the scatter color in any of the specific areas of the display (for example, S32), the game controller displays the scatter color in the specific areas by means of a texture mapping which makes the specific areas of the display a textural surface. With the display, the game controller excepts the symbols positioned inside the relevant display areas from the textural surface.

Also, in a slot machine (for example, the slot machine 1) playing method according to claim 13, a unit game, in which a redisposition of a plurality of symbols disposed on a display (for example, the display windows 10L, 10C and 10R in the lower image display panel 6) is performed, is repeated by a game controller (for example, the game controller 100).

At this time, every time the game controller executes the redisposition, the game controller decides whether or not the game controller displays the scatter color, a plurality of kinds of which have been prepared, in such a way as to include those colors, in any of specific areas (for example, Z1 to Z9) positioned one behind each of the plurality of symbols redisposed on the display (for example, S22).

Then, when the game controller executes the redisposition, the game controller displays the scatter color in any of the specific areas of the display, in accordance with details of the decision (S32).

Then, the game controller counts a number of the specific areas of the display in which the scatter color has been displayed separately for each kind of scatter color (for example, S44).

At this time, the game controller limits a subject when making the count to specific areas of the display, among the specific areas of the display in which the scatter color has been displayed, in which a scatter symbol has been redisposed (for example, S45).

Furthermore, the game controller awards a prize based on the number counted (for example, S46).

Also, in a slot machine (for example, the slot machine 1) playing method according to claim 14, a unit game, in which a redisposition of a plurality of symbols disposed on a display (for example, the display windows 10L, 10C and 10R in the lower image display panel 6) is performed, is repeated by a game controller (for example, the game controller 100).

At this time, every time the game controller executes the redisposition, the game controller decides whether or not the game controller displays a scatter color in any of specific areas (for example, Z1 to Z9) positioned one behind each of the plurality of symbols redisposed on the display (for example, S22).

Then, when the game controller executes the redisposition, the game controller displays the scatter color in any of the specific areas of the display, in accordance with details of the decision (S32).

At this time, the game controller displays the scatter color in the specific areas by means of a texture mapping which makes the specific areas of the display a textural surface. With the display, the game controller excepts the symbols positioned inside the relevant display areas from the textural surface.

Then, the game controller counts a number of the specific areas of the display in which the scatter color has been displayed (for example, S44).

At this time, the game controller limits a subject when making the count to specific areas of the display, among the specific areas of the display in which the scatter color has been displayed, in which a scatter symbol has been redisposed (for example, S45).

Furthermore, the game controller awards a prize based on the number counted (for example, S46).

Also, in a slot machine (for example, the slot machine 1) playing method according to claim 15, a unit game, in which a redisposition of a plurality of symbols disposed on a display (for example, the display windows 10L, 10C and 10R in the lower image display panel 6) is performed, is repeated by a game controller (for example, the game controller 100).

At this time, every time the game controller executes the redisposition, the game controller decides whether or not the game controller displays the scatter color, a plurality of kinds of which have been prepared, in such a way as to include those colors, in any of specific areas (for example, Z1 to Z9) positioned one behind each of the plurality of symbols redisposed on the display (for example, S22).

Then, when the game controller executes the redisposition, the game controller displays the scatter color in any of the specific areas of the display, in accordance with details of the decision (S32).

At this time, the game controller displays the scatter color in the specific areas by means of a texture mapping which makes the specific areas of the display a textural surface. With the display, the game controller excepts the symbols positioned inside the relevant display areas from the textural surface.

Then, the game controller counts a number of the specific areas of the display in which the scatter color has been displayed separately for each kind of scatter color (for example, S44).

Furthermore, the game controller awards a prize based on the number counted (for example, S46).

Also, in a slot machine (for example, the slot machine 1) playing method according to claim 16, a unit game, in which a redisposition of a plurality of symbols disposed on a display (for example, the display windows 10L, 10C and 10R in the lower image display panel 6) is performed, is repeated by a game controller (for example, the game controller 100).

At this time, every time the game controller executes the redisposition, the game controller decides whether or not the game controller displays the scatter color, a plurality of kinds of which have been prepared, in such a way as to include those colors, in any of specific areas (for example, Z1 to Z9) positioned one behind each of the plurality of symbols redisposed on the display (for example, S22).

Then, when the game controller executes the redisposition, the game controller displays the scatter color in any of the specific areas of the display, in accordance with details of the decision (S32).

At this time, the game controller displays the scatter color in the specific areas by means of a texture mapping which makes the specific areas of the display a textural surface. With the display, the game controller excepts the symbols positioned inside the relevant display areas from the textural surface.

Then, the game controller counts a number of the specific areas of the display in which the scatter color has been displayed separately for each kind of scatter color (for example, S44).

At this time, the game controller limits a subject when making the count to specific areas of the display, among the specific areas of the display in which the scatter color has been displayed, in which a scatter symbol has been redisposed (for example, S45).

Furthermore, the game controller awards a prize based on the number counted (for example, S46).

That is, in the invention, in the slot machine in which the scatter color is displayed when the symbols are redisposed, by the “any” dividend, which awards a prize based on the number of specific areas of the display in which the scatter color is displayed, being performed, as the “any” dividend is endowed with a diversity, an entertainment aspect is increased.

Additional objects and advantage of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE INVENTION OF THE DRAWINGS

The accompanying drawings, which are incorporated in and constitute a part of the specification, illustrate embodiments of the invention, and together with the general description given above and the detailed description of the embodiments given below, serve to explain the principals of the invention.

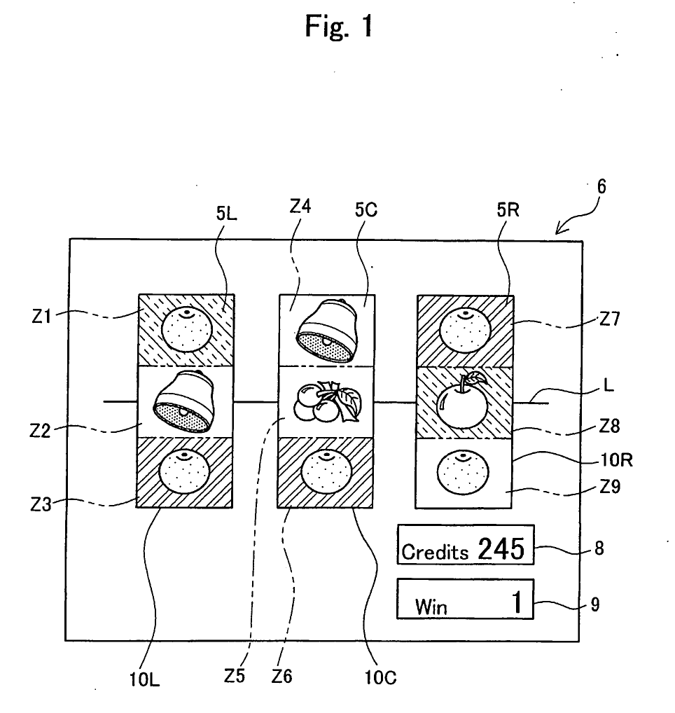

FIG. 1 shows an example of an image displayed on a lower image display panel;

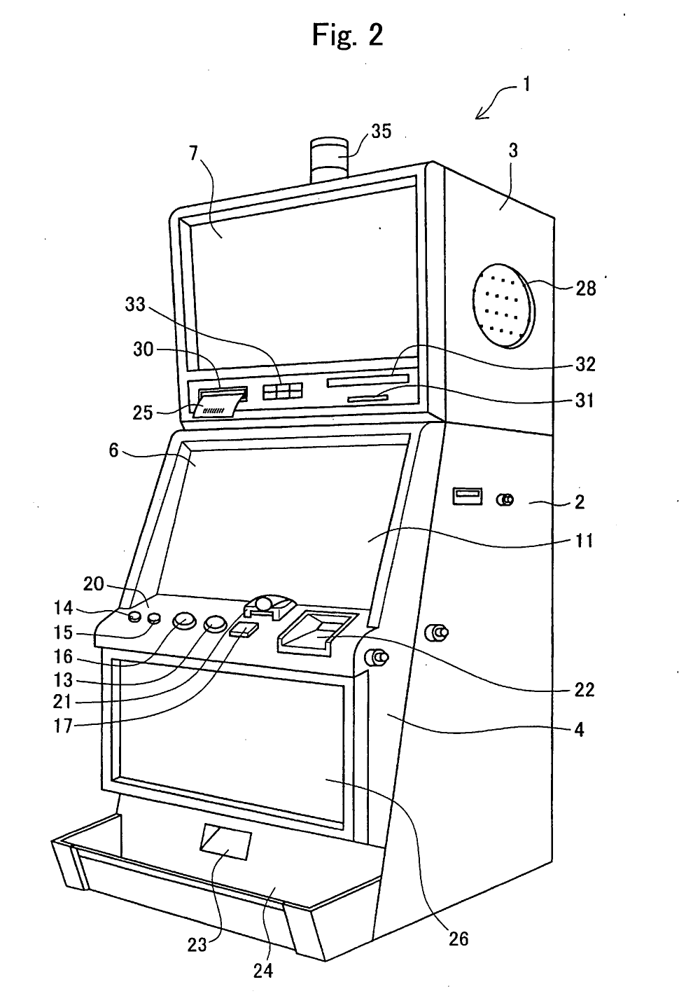

FIG. 2 is a perspective view showing an appearance of a slot machine according to an embodiment;

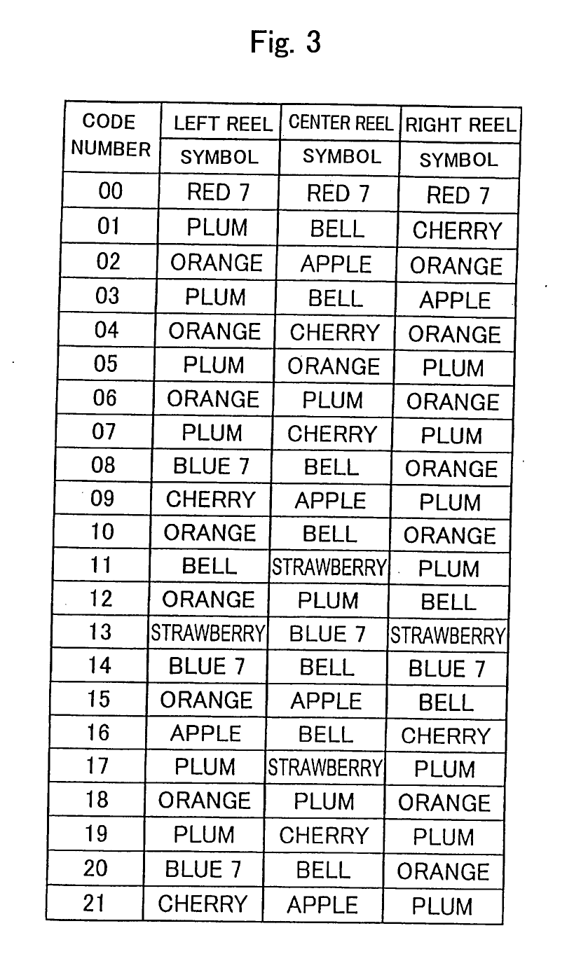

FIG. 3 is a schematic diagram showing a symbol column depicted on a peripheral surface of each video reel;

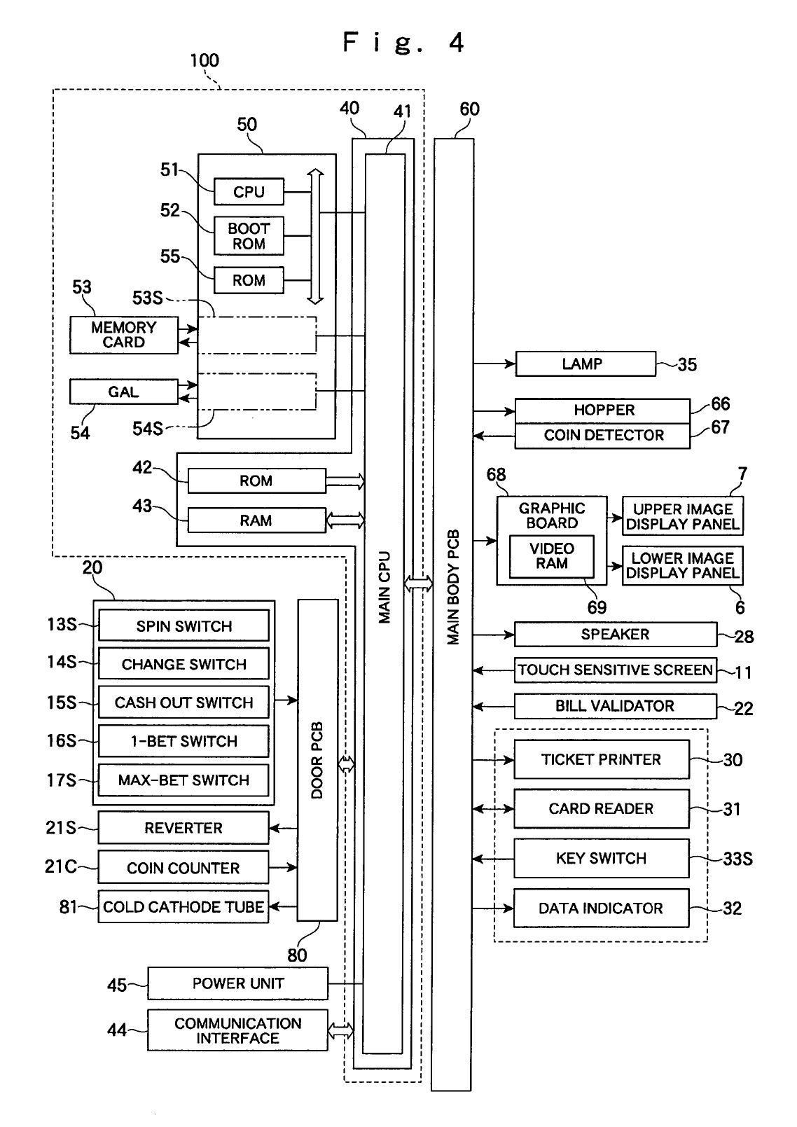

FIG. 4 is a block diagram schematically showing a control system of the slot machine according to the embodiment;

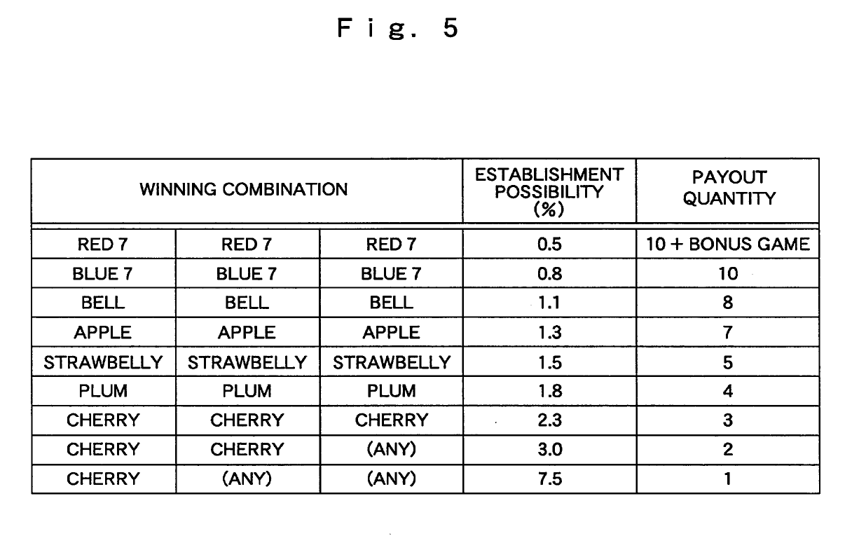

FIG. 5 shows a payout table showing winning combinations, and an establishment possibility and dividend of each winning combination, of the slot machine according to the embodiment;

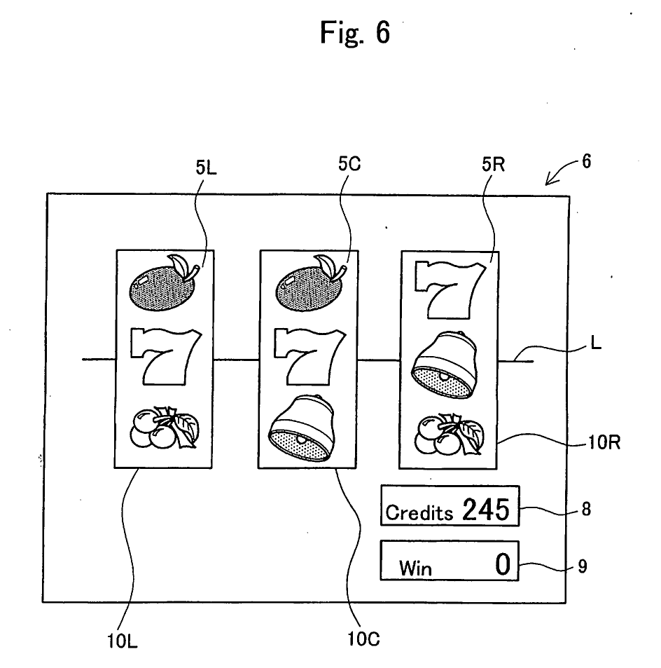

FIG. 6 shows one example of an image displayed on the lower image display panel;

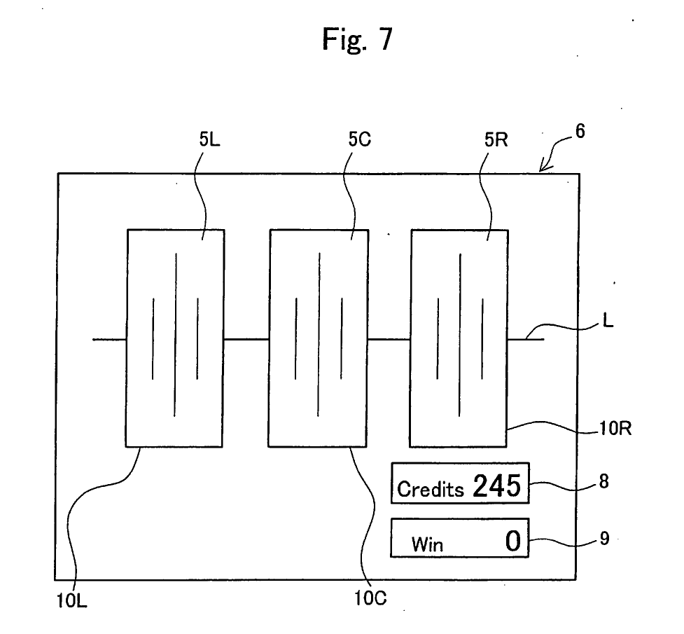

FIG. 7 shows one example of an image displayed on the lower image display panel;

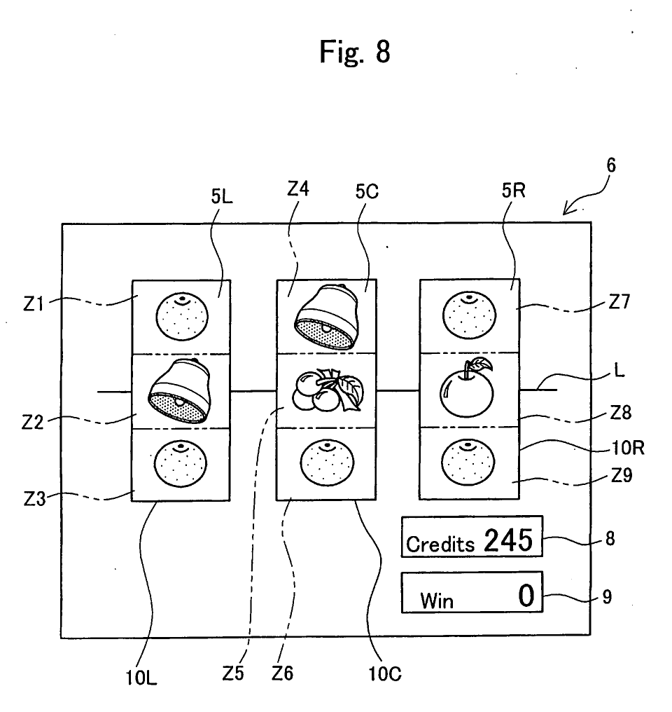

FIG. 8 shows one example of an image displayed on the lower image display panel;

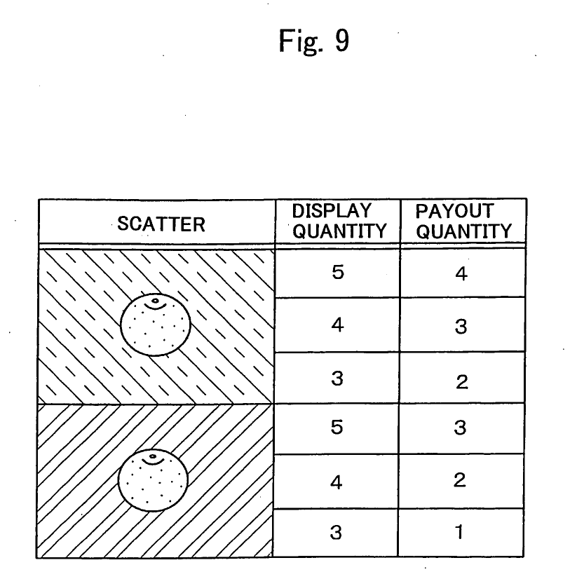

FIG. 9 shows a payout table showing an “any” dividend of the slot machine according to the embodiment;

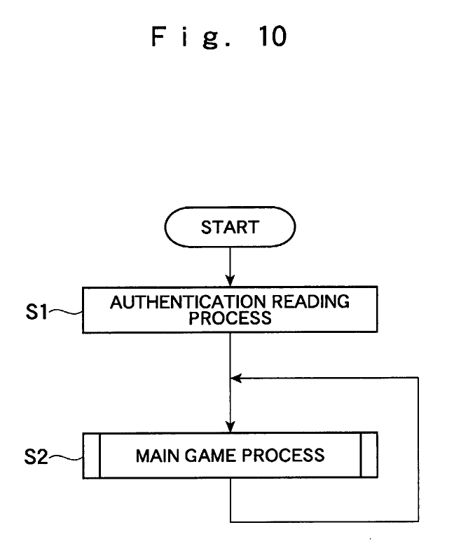

FIG. 10 is a flowchart of a main control process program in the slot machine according to the embodiment;

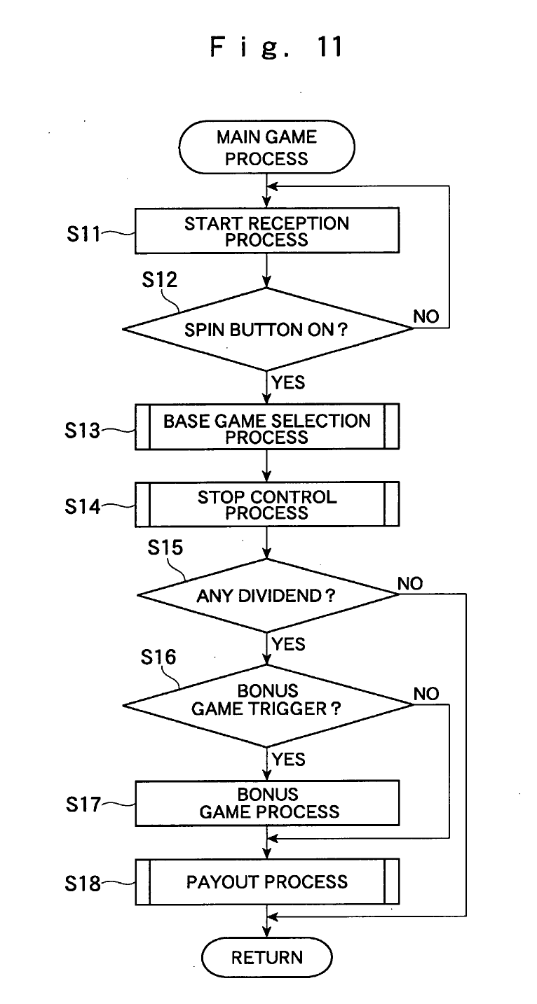

FIG. 11 is a flowchart of a main game process program in the slot machine according to the embodiment;

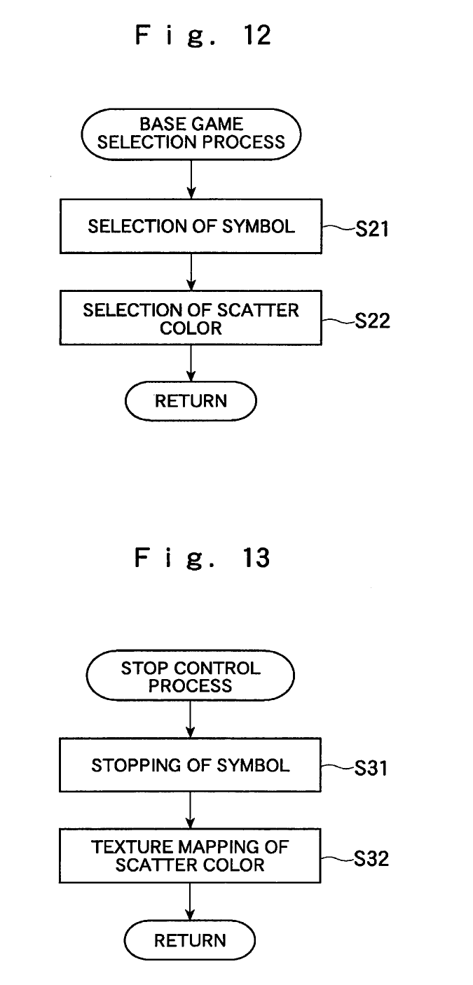

FIG. 12 is a flowchart of a base game selection process program in the slot machine according to the embodiment;

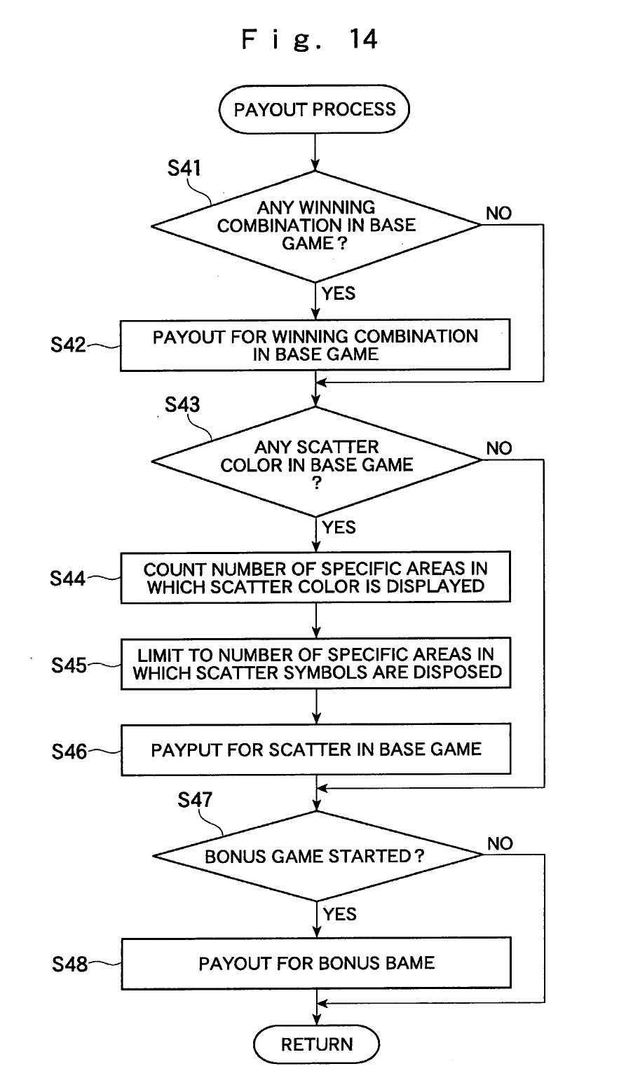

FIG. 13 is a flowchart of a stop control process program in the slot machine according to the embodiment; and

FIG. 14 is a flowchart of a payout process program in the slot machine according to the embodiment.

### DESCRIPTION OF THE PREFERRED EMBODIMENTS

In a game carried out in a slot machine according to an embodiment, a game is carried out in which, by simultaneously revolving three video reels, on each of which a plurality of symbols is depicted, sequentially stopping them, and redisposing the disposed plurality of symbols, three symbols are combined on a winning line. At this time, regardless of whether or not they are on the winning line, a scatter color may be displayed behind the redisposed symbols. Then, in the event that a scatter symbol is included in the redisposed symbols, a number of combinations in which the scatter color is displayed behind the scatter symbol is counted. This count is carried out separately for each color of scatter color. Then, a predetermined dividend amount is awarded to a player, in accordance with the number counted, as an “any” dividend.

Hereafter, a detailed description will be given of a gaming machine according to the invention, based on one embodiment realized as a slot machine, with reference to the drawings.

First, a description will be given of a skeleton configuration of a slot machine 1 according to the embodiment, based on FIG. 2. FIG. 2 is an external perspective view of the slot machine according to the embodiment.

The slot machine 1 according to the embodiment includes a cabinet 2, a top box 3 disposed on top of the cabinet 2, and a main door 4 provided on a front of the cabinet 2.

Also, an upper image display panel 7 is provided in a front of the top box 3. Herein, the upper image display panel 7, being configured of a heretofore known transparent liquid crystal panel, normally displays a demonstration image, or information relating to the game of the slot machine 1, such as game rules or a payout table.

Meanwhile, a lower image display panel 6 is provided in a front of the main door 4.

At this point, a description will be given of an image, relating to the game of the slot machine 1, displayed on the lower image display panel 6. FIG. 6 to FIG. 8 show, as one example thereof, details displayed on the lower image display panel 6. During a base game, as shown in FIG. 6 to FIG. 8, symbols depicted on a hypothetical peripheral surface of each video reel 5L, 5C and 5R can be visually perceived in display windows 10L, 10C and 10R, in the lower image display panel 6. FIG. 6 and FIG. 8 show a disposition condition, or a redisposition condition, of the symbols depicted on the hypothetical peripheral surface of each video reel 5L, 5C and 5R, while FIG. 7 shows a revolving condition of the symbols depicted on the hypothetical peripheral surface of each video reel 5L, 5C and 5R.

A symbol column (refer to FIG. 3) having 22 symbols is depicted on the hypothetical peripheral surface of each of the three video reels 5L, 5C and 5R.

Also, a touch sensitive screen 11 (refer to FIG. 2) being provided on a front of the lower image display panel 6, the player can input various kinds of instruction by operating the touch sensitive screen 11 (refer to FIG. 2).

Furthermore, a credit quantity display portion 8 and a payout quantity display portion 9 are provided on the lower image display panel 6. A credit quantity which the player currently owns is displayed in the credit quantity display portion 8. A dividend amount to be awarded in the event that a combination of symbols redisposed on a winning line L is a predetermined combination, a dividend amount when the heretofore described “any” dividend is acquired, and a dividend amount acquired in a bonus game are displayed as a payout quantity in the payout quantity display portion 9.

That is, the three visually perceivable display windows 10L, 10C and 10R being displayed in the lower image display panel 6, three each of the symbols depicted on the hypothetical peripheral surface of each video reel 5L, 5C and 5R are redisposed via the display windows 10L, 10C and 10R.

At this point, the display window 10L is divided into three specific areas, Z1, Z2 and Z3, as shown in FIG. 8. Then, one symbol is redisposed in each specific area Z1, Z2 and Z3. Also, the display window 10C is divided into three specific areas, Z4, Z5 and Z6, as shown in FIG. 8. Then, one symbol is redisposed in each specific area Z4, Z5 and Z6. Also, the display window 10R is divided into three specific areas, Z7, Z8 and Z9, as shown in FIG. 8. Then, one symbol is redisposed in each specific area Z7, Z8 and Z9.

Also, in the lower image display panel 6, one winning line L is formed, horizontally crossing the three display windows 10L, 10C and 10R. The winning line L regulates the combination of symbols.

During the bonus game, a prescribed bonus game screen, on which the display windows 10L, 10C and 10R (including each video reel 5L, 5C and 5R) and the winning line L are in a deleted condition, is displayed along with the credit quantity display portion 8 and the payout quantity display portion 9.

Returning to FIG. 2, a control panel 20, equipped with a plurality of buttons with which instructions from the player relating to a game implementation are input, a coin acceptor 21 which accepts a coin, which is a game medium, into the cabinet 2, and a bill validator 22 are provided below the lower image display panel 6.

A SPIN button 13, a CHANGE button 14, a CASH OUT button 15, a 1-BET button 16, and a MAX-BET button 17 are provided on the control panel 20. The SPIN button 13 is an operating device for inputting an instruction to cause a start of the revolving of the video reels 5L, 5C and 5R. The CHANGE button 14 is an operating device used when requesting a changing of money from an attendant of a game establishment. The CASH OUT button 15 is an operating device for inputting an instruction to pay coins (one credit corresponds to one coin) from a coin payout opening 23 into a coin tray 24, in accordance with the credit quantity which the player owns, or an instruction to pay out by means of a bar-coded ticket 25, to be described hereafter.

The 1-BET button 16 is an operating device for receiving an instruction to bet one credit, from among the credits which the player owns, on the game. Also, the MAX-BET button 17 is an operating device for receiving an instruction to bet a maximum credit quantity (in the embodiment, 50 credits), from among the credits which the player owns, which can be bet on one game.

A reverter 21S (refer to FIG. 4) and a coin counter 21C (refer to FIG. 4) are provided inside the coin acceptor 21. Then, a legitimacy or otherwise of a coin inserted into the coin acceptor 21 being distinguished by the reverter 21S (refer to FIG. 4), coins other than legitimate ones are ejected from the coin payout opening 23. Also, accepted legitimate coins are detected by the coin counter 21C (refer to FIG. 4), and a number thereof is counted.

Also, the bill validator 22, as well as distinguishing a legitimacy or otherwise of a bill, accepts a legitimate bill into the cabinet 2. Then, the bill inserted into the cabinet 2 is converted into a number of coins, and a credit equivalent to the converted number of coins is added as the player's owned credit. The bill validator 22 is configured in such a way as to be able to read the bar-coded ticket 25 to be described hereafter. Also, a belly glass 26, on which is depicted a character or the like of the slot machine 1, is provided on a lower front of the main door 4, that is, below the control panel 20.

In the slot machine 1 according to the embodiment, a coin, a bill, or electronic valuable information (a credit) equivalent to them, is used as a game medium. However, the game medium applicable to the invention not being limited to these, it is also possible to propose, for example, a medal, a token, electronic money or a ticket.

Also, a ticket printer 30, a card reader 31, a data indicator 32 and a keypad 33 are provided below the upper image display panel 7.

Herein, the ticket printer 30 is a printing device which prints a bar code, into which are encoded data such as a credit quantity, a date and time, and an identification number of the slot machine 1, onto a ticket, and outputs the ticket as the bar-coded ticket 25. Then, the player can cause another gaming machine to read the output bar-coded ticket 25 and carry out a game on the relevant gaming machine, or use it for procedures in a prescribed part of the game establishment.

The card reader 31 carries out a reading of data from a smart card, and a writing of data onto the smart card. The smart card is a card which the player possesses, on which are stored, for example, data relating to a history of a game which the player has played.

The data indicator 32, being configured of a fluorescent display or the like, displays, for example, data read by the card reader 31, or data input by the player via the keypad 33. Also, the keypad 33 is used when inputting instructions or data relating to an issuing or the like of the ticket. Furthermore, a lamp 35 is provided on a top of the top box 3. The lamp 35 is illuminated in a prescribed illumination aspect when calling an assistant or the like of the game establishment, such as when an error has occurred in the slot machine 1.

Reference numeral 28 is a speaker.

Continuing, a description will be given, based on FIG. 3, of the symbols depicted on the hypothetical peripheral surfaces of the video reels 5L, 5C and 5R and redisposed, while scrolling, via the display windows 10L, 10C and 10R of the lower image display panel 6 during the game. FIG. 3 is a schematic diagram showing the symbol columns depicted on the hypothetical peripheral surface of each video reel 5L, 5C and 5R.

22 symbols are depicted on the hypothetical peripheral surface of each of the left video reel 5L, the center video reel 5C, and the right video reel 5R. Each symbol column is configured by symbols “RED 7”, “BLUE 7”, “BELL”, “CHERRY”, “STRAWBERRY”, “PLUM”, “ORANGE” and “APPLE” being combined. As shown in FIG. 3, prescribed kinds of symbol are disposed in a prescribed order on the hypothetical peripheral surface of each video reel 5L, 5C and 5R.

In the event that three “BLUE 7”'s, “CHERRY”'s, “STRAWBERRY”'s, “PLUM”'s or “APPLE”'s are redisposed on the winning line L, a predetermined dividend amount is awarded to the player (refer to FIG. 5). Also, with regard to “CHERRY”, even in the event that one or two are redisposed on the winning line L, depending on that quantity, a predetermined dividend amount is awarded to the player (refer to FIG. 5).

Furthermore, “ORANGE” is the scatter symbol which is an object of the “any” dividend. However, in the slot machine 1 according to the embodiment, even in the event that “ORANGE” is redisposed in the display windows 10L, 10C and 10R, the count being limited to “ORANGE”'s in which the scatter color is displayed in the specific areas Z1 to Z9 behind them, a predetermined dividend amount is awarded to the player depending on a number of “ORANGE”'s counted (refer to FIG. 9).

Two colors of scatter color are prepared in the slot machine 1 according to the embodiment. Also, the number of “ORANGE”'s is counted separately for each color of scatter color displayed in the specific areas Z1 to Z9 behind the “ORANGE”'s (refer to FIG. 9).

That is, of each specific area Z1 to Z9 of the display windows 10L, 10C and 10R of the lower image display panel 6, a number in which a combination of “ORANGE” and the scatter color is established is counted separately for each color of scatter color, and a dividend is awarded to the player depending on the counted number (refer to FIG. 9).

Also, in the event that three “RED 7”'s are redisposed on the winning line L, as well as a predetermined dividend amount being awarded to the player, a shift is made to the bonus game. Herein, the game carried out in the slot machine 1 according to the embodiment is configured of two game modes, the base game and the bonus game. In the base game, the game is carried out which redisposes a specific combination of symbols on the winning line L, using the video reels 5L, 5C and 5R. At this time, the game of the heretofore mentioned “any” dividend, in which “ORANGE” and the color of the scatter color are combined, is carried out simultaneously. Meanwhile, in the bonus game, a game is carried out in which three treasure boxes, which are choices, are displayed on the lower image display panel 6, and a dividend correlated to a treasure box selected by the player, from among the treasure boxes displayed, is awarded. Details of the bonus game will be omitted.

Then, by some of the symbol columns depicted on the hypothetical peripheral surfaces of the video reels 5L, 5C and 5R, shown in FIG. 3, being displayed in the display windows 10L, 10C and 10R, one symbol being disposed in each specific area Z1 to Z9 of the display windows 10L, 10C and 10R, a total of nine symbols are disposed. Furthermore, after a bet quantity is fixed by an operation of the 1-BET button 16 or MAX-BET button 17, on pressing the SPIN button 13, the symbol columns depicted on the hypothetical peripheral surfaces of the video reels 5L, 5C and 5R, shown in FIG. 3, are scroll displayed from a top direction to a bottom direction in the display windows 10L, 10C and 10R, in conjunction with the revolving of the video reels 5L, 5C and 5R (refer to FIG. 7). Then, after a prescribed time has elapsed, in conjunction with the stopping of the video reels 5L, 5C and 5R, by some of the symbol columns depicted on the hypothetical peripheral surfaces of the video reels 5L, 5C and 5R, shown in FIG. 3, being displayed in each specific area Z1 to Z9 of the display windows 10L, 10C and 10R, one symbol being redisposed in each specific area Z1 to Z9 of the display windows 10L, 10C and 10R, a total of nine symbols are redisposed (refer to FIG. 6). Furthermore, each kind of winning combination (refer to FIG. 5) being predetermined based on each combination of symbols, when a combination of symbols corresponding to a winning combination is realized by the symbols redisplayed on the winning line L, a dividend amount corresponding to the redisplayed winning combination is awarded to the player. Also, the combination of “ORANGE” and the color of the scatter color (refer to FIG. 9) being predetermined, when the combination of “ORANGE” and the color of the scatter color is realized in any of the specific areas Z1 to Z9 of the display windows 10L, 10C and 10R, a dividend amount corresponding to the number of combinations of “ORANGE” and the color of the scatter color is awarded to the player.

Next, a description will be given of a configuration relating to a control system of the slot machine 1 according to the embodiment, based on FIG. 4. FIG. 4 is a block diagram schematically showing the control system of the slot machine 1 according to the embodiment.

As shown in FIG. 4, the control system of the slot machine 1 is basically configured of a mother board 40 and a gaming board 50.

First, to give a description of the gaming board 50, the gaming board 50 includes a CPU 51, an ROM 55 and a boot ROM 52, which are mutually connected via an internal bus, a card slot 53S compatible with a memory card 53, and an IC socket 54S compatible with a GAL (Generic Array Logic) 54.

The memory card 53, being configured of a non-volatile memory, is a recording medium in which the game program and a game system program (hereafter referred to as the game program etc.) are stored. A selection program is included in the game program recorded on the memory card 53. The selection program is a program for determining symbols (the code numbers corresponding to the symbols) of each video reel 5L, 5C and 5R to be redisposed on the winning line L. Then, symbol weighting data corresponding to each of a plurality of kinds of payout ratio (for example, 80%, 84% and 88%) are included in the selection program. The symbol weighting data are data which indicate, for each of the three video reels 5L, 5C and 5R, a correlation relationship between the code number of each symbol (refer to FIG. 3), and one or a plurality of random numbers belonging to a prescribed range of numbers (0 to 255). That is, one or a plurality of random numbers being correlated to the code number of one symbol, by a random number being extracted by a selection, a symbol specified by the relevant random number is redisplayed.

Also, the payout ratio being fixed based on payout ratio setting data transmitted from the GAL 54, the selection is carried out based on symbol weighting data corresponding to this payout ratio.

Also, a program for determining whether or not the scatter color is displayed in each specific area Z1 to Z9 of the display windows 10L, 10C and 10R, and furthermore, determining the color of the scatter color in the event that the scatter color is displayed, is included in the selection program recorded as the game program in the memory card 53. Also, scatter color weighting data corresponding to each of the plurality of kinds of payout ratio (for example, 80%, 84% and 88%) are included in the selection program. The scatter color weighting data are data which indicate, for each of the nine specific areas Z1 to Z9, a correlation relationship between a code number of the color of the scatter color (including also a case in which the scatter color is not displayed), and one or a plurality of random numbers belonging to the prescribed range of numbers (0 to 255). That is, one or a plurality of random numbers being correlated to the code number of one color, by a random number being extracted by the selection, the scatter color is not displayed, or a scatter color of a color specified by the relevant random number is displayed.

Also, the payout ratio being fixed based on payout ratio setting data transmitted from the GAL 54, the selection is carried out based on scatter color weighting data corresponding to this payout ratio.

Also, the card slot 53S, being configured in such a way that the memory card 53 can be inserted into and removed from it, is connected to the mother board 40 via an IDE bus. Consequently, by carrying out a rewriting of the game program etc. recorded on the memory card 53, it is possible to change a type and details of the game carried out on the slot machine 1. Also, by replacing with the memory card 53 on which another game program etc. is recorded, it is also possible to change the type and details of the game carried out on the slot machine 1.

In addition to the program relating to the game implementation, and image data, sound data and the like transmitted during the game, image data of the symbols depicted on the hypothetical peripheral surface of each video reel 5L, 5C and 5R, image data of the game rules, payout table and the like, demonstration image data, and data when displaying the scatter color in texture mapping, are included in the game program.

The GAL 54 is one kind of PLD having an OR fixed type array configuration. The GAL 54 including a plurality of input ports and output ports, when prescribed data are input into the input ports, data corresponding to the relevant data are transmitted from the output ports. The data transmitted from the output ports are the heretofore described payout ratio setting data.

Also, the IC socket 54S, being configured in such a way that the GAL 54 can be attached to and removed from it, is connected to the mother board 40 via a PCI bus. Consequently, by carrying out a rewriting of the GAL 54, or a replacement of the GAL 54 itself, it is possible to change the payout ratio setting data transmitted from the GAL 54.

The CPU 51, ROM 55 and boot ROM 52, which are mutually connected via the internal bus, are connected to the mother board 40 via the PCI bus. The PCI bus, as well as carrying out a signal transmission between the mother board 40 and the gaming board 50, carries out a supply of power from the mother board 40 to the gaming board 50. Country identification information and an authentication program are stored in the ROM 55. A preliminary authentication program, and a program (a boot code) for the CPU 51 to boot up the preliminary authentication program, and the like are stored in the boot ROM 52.

The authentication program is a program (an alteration checking program) for authenticating the game program etc. The authentication program is described in accordance with an alteration checking procedure of the game program etc., which is a subject of an authentication downloading process. The preliminary authentication program, being a program for authenticating the heretofore described authentication program, is described in accordance with an alteration checking procedure of the authentication program, which is a subject of an authentication process.

Continuing, a description will be given of the mother board 40. The mother board 40, being configured using a commercially available general-purpose mother board (a printed circuit board on which are mounted basic parts of a personal computer), includes a main CPU 41, an ROM 42, and an RAM 43.

A program such as a BIOS, being included in a memory device such as a flash memory, executed by the main CPU 41, and permanent data such as a selection table and a payout table (refer to FIGS. 5 and 9) of the base game and bonus game, are stored in the ROM 42. When the BIOS is executed by the main CPU 41, an initialization process of prescribed peripheral devices being carried out, a downloading process of the game program etc. stored on the memory card 53 is started via the gaming board 50.

The data and programs used when the main CPU 41 operates are stored in the RAM 43. Also, the RAM 43 can store various kinds of program, such as the authentication program and game program etc. read via the gaming board 50, and various kinds of information such as a number of credits which the player currently owns.

Also, a communication interface 44 is connected to the mother board 40. The communication interface 44 is a communication device for carrying out a communication with a server or the like, installed in the game establishment, via a communication line. The slot machine 1 communicates bet information, a selection result of a base game selection process and the like in a main game process, to be described hereafter (refer to S2 of FIG. 10), to the server and the like, via the communication interface 44.

Also, a main body PCB 60 and a door PCB 80, to be described hereafter, are each connected to the mother board 40 via a USB. Furthermore, a power unit 45 is connected to the mother board 40. When the power is supplied to the mother board 40 from the power unit 45, the main CPU 41 of the mother board 40 is booted up. Furthermore, the power is supplied to the gaming board 50 via a PCI bus, and the CPU 51 is booted up.

Also, a game controller 100 is configured of the mother board 40 and the gaming board 50.

Meanwhile, an instrument or a device, which generates an input signal with respect to the game controller 100, and an instrument or a device, an operation of which is controlled by a control signal from the game controller 100, are connected to the main body PCB 60 and the door PCB 80. The game controller 100, based on the input signal input into the game controller 100, executes the game program etc. stored in the RAM 43. Then, by carrying out a prescribed calculation process, the game controller 100 carries out a storing of a calculation result in the RAM 43, and a control process with respect to each instrument or device.

The lamp 35, a hopper 66, a coin detector 67, a graphic board 68, the speaker 28 (refer to FIG. 2), the touch sensitive screen 11, the bill validator 22, the ticket printer 30, the card reader 31, a KEY switch 33S and the data indicator 32 are connected to the main body PCB 60.

Herein, the touch sensitive screen 11 being disposed in the front of the lower image display panel 6, it is possible to identify a coordinate position of a portion touched by the player, and distinguish, based on the identified coordinate position information, where the player has touched, and furthermore, in which direction the touched place has moved.

The hopper 66, being installed in the cabinet 2, based on the control signal transmitted from the game controller 100, pays a prescribed number of coins into the coin tray 24 through the coin payout opening 23. The coin detector 67, being positioned inside the coin payout opening 23, when detecting that the prescribed number of coins has been paid out through the coin payout opening 23, transmits an input signal to the game controller 100.

The graphic board 68, based on the control signal from the game controller 100, controls an image display on the upper image display panel 7 and the lower image display panel 6. For example, the credit quantity which the player owns, stored in the RAM 43, is displayed in the credit quantity display portion 8. Then, the payout quantity of credits according to the dividend is displayed in the payout quantity display portion 9.

Herein, the graphic board 68 includes a VDP (Video Display Processor), which generates image data based on the control signal from the game controller 100, and a video RAM 69 or the like, which temporarily stores the image data generated by the VDP. The image data used when the image data are generated by the VDP are included in the game program.

Also, the graphic board 68, based on the control signal from the game controller 100, also carries out a display control of the revolving and stopping of the video reels 5L, 5C and 5R on the lower image display panel 6 (refer to FIG. 6, FIG. 7 and FIG. 8).

Also, a preference circuit which, giving priority to the display of the symbols of the video reels 5L, 5C and 5R, excludes the symbols of the video reels 5L, 5C and 5R from a subject of the texture mapping, is included in the graphic board 68.

Also, the bill validator 22, as well as distinguishing the legitimacy or otherwise of the bill or bar-coded ticket 25, accepts the legitimate bill or bar-coded ticket 25 into the cabinet 2. The bill validator 22, when accepting the legitimate bill, transmits the input signal to the game controller 100 based on the value of the bill. Also, based on the number of coins recorded on the legitimate bar-coded ticket 25, the bill validator 22 transmits an input signal to the game controller 100.

The ticket printer 30, based on the control signal transmitted from the game controller 100, prints the bar code, into which are encoded the data on the credit quantity etc. stored in the RAM 43, on a ticket, and outputs it as the bar-coded ticket 25.

Also, the card reader 31 reads the data from the smart card and transmits them to the game controller 100 and, based on the control signal from the game controller 100, carries out the writing of the data onto the smart card. The KEY switch 33S, being provided on the keypad 33, when the keypad 33 is operated by the player, transmits a prescribed input signal to the game controller 100. The data indicator 32, based on the control signal transmitted from the game controller 100, displays the data read by the card reader 31 and the data input by the player via the keypad 33.

Meanwhile, the control panel 20, a reverter 21S, a coin counter 21C and a cold cathode tube 81 are connected to the door PCB 80. A SPIN switch 13S corresponding to the SPIN button 13, a CHANGE switch 14S corresponding to the CHANGE button 14, a CASH OUT switch 15S corresponding to the CASH OUT button 15, a 1-BET switch 16S corresponding to the 1-BET button 16, and a MAX-BET switch 17S corresponding to the MAX-BET button 17 are provided on the control panel 20. Each switch, when the corresponding button is operated by the player, transmits an input signal to the game controller 100.

The coin counter 21C, being provided inside the coin acceptor 21, distinguishes the legitimacy or otherwise of a coin inserted into the coin acceptor 22 by the player. Coins other than legitimate ones being ejected from the coin payout opening 23, the coin counter 21C, when detecting the legitimate coin, transmits an input signal to the game controller 100.

The reverter 21S, operating based on a control signal transmitted from the game controller 100, sorts the coins recognized as the legitimate coins by the coin counter 21C into a cash box (not shown) installed in the slot machine 1, or into the hopper 66. The cold cathode tube 81, being installed on a back of the lower image display panel 6 and the upper image display panel 7, functions as a backlight, coming on based on a control signal transmitted from the game controller 100.

Next, a description will be given, based on FIG. 5, of winning combinations, and dividends thereof, in a case of carrying out the base game in the slot machine 1 according to the embodiment using the video reels 5L, 5C and 5R. FIG. 5 is a payout table showing the winning combinations, and an establishment possibility and the dividend of each winning combination, in the case of carrying out the base game using the video reels 5L, 5C and 5R.

Herein, the dividends shown in FIG. 5 indicate dividends in a case in which the bet quantity is “1”. Consequently, in the case in which the bet quantity is “1”, a value of the dividend shown in FIG. 5 is added to the credit, but in a case in which the bet quantity is “2” or greater, a product of the value of the dividend shown in FIG. 5 multiplied by the relevant bet quantity is added to the credit.

Also, the establishment possibility of each winning combination shown in FIG. 5 indicates a case in which a payout ratio in other than the bonus game is 88%. The establishment possibility in the figure indicates a possibility that the relevant wining combination is established in a case of determining the code number of each video reel 5L, 5C and 5R, based on three random numbers, referring to the symbol weighting data. That is, it is not one in which the random number is correlated to each winning combination.

For example, an establishment possibility of a bonus game trigger is 0.5%. In the event that the bonus game trigger is won, three “RED 7” symbols being redisposed on the winning line L, as well as ten credits being paid out as the dividend, the bonus game occurs.

Also, an establishment possibility of “BLUE 7” is 0.8%. In the event that this winning combination is established, three “BLUE 7” symbols being redisposed on the winning line L, ten credits per one bet are paid out as the dividend.

Also, an establishment possibility of “BELL” is 1.1%. In the event that this winning combination is established, three “BELL” symbols being redisposed on the winning line L, eight credits per one bet are paid out as the dividend.

Hereafter, in the same way, the establishment possibility and payout quantity are set for each winning combination shown in FIG. 5. However, in the event that a combination of symbols which does not correspond to any combination among the winning combinations shown in FIG. 5 has been redisposed, being a loss, no payout of the credit is carried out for the loss.

Next, a description will be given, based on FIG. 9, of “any” dividends in a case of carrying out the base game in the slot machine 1 according to the embodiment using the video reels 5L, 5C and 5R. FIG. 9 is a payout table showing the “any” dividends in the case of carrying out the base game using the video reels 5L, 5C and 5R. The establishment possibility is omitted in the payout table shown in FIG. 9.

Herein, the “any” dividends shown in FIG. 9 indicate, for each color of scatter color, dividends based on the number of combinations in the specific areas Z1 to Z9 of the scatter color and “ORANGE”, which is the scatter symbol.

For example, to give a description of a combination of a color of scatter color and “ORANGE” shown in an upper portion of FIG. 9, four credits being paid out as the dividend in the event that there are five combinations in the specific areas Z1 to Z9 of the color of scatter color and “ORANGE” shown in the upper portion of FIG. 9, hereafter, three credits are paid out in the event that there are four combinations, and two credits are paid out in the event there are three combinations.

Also, to give a description of a combination of a kind of scatter color and “ORANGE” shown in a lower portion of FIG. 9, three credits being paid out as the dividend in the event that there are five combinations in the specific areas Z1 to Z9 of the color of scatter color and “ORANGE” shown in the lower portion of FIG. 9, hereafter, two credits are paid out in the event that there are four combinations, and one credit is paid out in the event there are three combinations.

As shown in FIG. 9, two scatter colors are prepared in the slot machine 1 according to the embodiment.

Continuing, a description will be given, while referring to the drawings, of a main control program executed in the slot machine 1 according to the embodiment. FIG. 10 is a flowchart of the main control program.

In the slot machine 1, it is taken that the memory card 53 is already inserted in the card slot 53S of the gaming board 50, and that the GAL 54 is attached to the IC socket 54S.

Firstly, when the power is turned on in the power unit 45, the game controller 100 is booted up, and an authentication reading process of step (hereafter abbreviated to S) 1 is carried out. In the authentication reading process, the mother board 40 and gaming board 50, which configure the game controller 100, each carry out a distinct process in parallel.

That is, in the gaming board 50, the CPU 51 carries out a reading of the preliminary authentication program stored in the boot ROM 52 and, in accordance with the preliminary authentication program read, carries out the preliminary authentication confirming and certifying in advance that no alteration of the authentication program has been carried out, before it is downloaded onto the mother board 40.

Meanwhile, in the mother board 40, the main CPU 41 executes the BIOS stored in the ROM 42 and, expanding compressed data embedded in the BIOS to the RAM 43, carries out an execution of the BIOS expanded to the RAM 43, and a diagnosis and initialization of each kind of peripheral device.

Subsequently, the game controller 100 reads the authentication program stored in the ROM 55, and carries out an authentication confirming and certifying that the game program etc. stored on the memory card 53 inserted in the card slot 53S has not been altered. If the authentication process finishes normally, the game controller 100 writes the game program etc. which have been the authentication subjects (authenticated) into the RAM 43, and acquires the country identification information and the payout ratio setting data.

After carrying out the heretofore described process, the game controller 100 finishes the authentication reading process.

Then, in S2, the game controller 100, by sequentially reading the game program etc. authenticated by the heretofore described authentication reading process of S1 from the RAM 43, and executing them, carries out the main game process. By executing the main game process, the game in the slot machine 1 according to the embodiment is carried out. Then, the main game process is executed repeatedly for as long as the power is supplied to the slot machine 1.

Next, a description will be given, based on FIG. 11, of a sub-process of the main game process of S2. FIG. 11 is a flowchart of main game process programs in the slot machine 1 according to the embodiment. Each program shown hereafter in the flowchart in FIG. 11 is stored in the ROM 42 and RAM 43 included in the slot machine 1, and executed by the game controller 100.

First, as shown in FIG. 11, after the game controller 100 has carried out a prescribed initial setting in S11, it carries out a start reception process, setting a bet quantity and the like with respect to the coins inserted and the winning line L. At this time, in the start reception process, the coin insertion, and a betting operation using the 1-BET button 16 or MAX-BET button 17, are carried out by the player.

Next, in S12, the game controller 100 carries out a determination of whether or not the SPIN button 13 has been pressed. Whether or not the SPIN button 13 has been pressed is determined based on whether or not an input signal from the SPIN switch 13S has been received.

If the SPIN button 13 has not been pressed (S12: No), the game controller 100 returns to the start reception process (S11). At this time, an operation of a revision or the like of the bet quantity is possible. Contrarily, if the SPIN button 13 has been pressed (S12: Yes), the game controller 100, as well as subtracting the bet quantity set with respect to the winning line L, based on the operation of the 1-BET button 16 or MAX-BET button 17, from the owned credit quantity, stores the bet quantity in the RAM 43 as bet information.

Then, in step S13 onwards, the game controller 100 executes a base game process using the video reels 5L, 5C and 5R.

Firstly, in S13, the game controller 100 carries out a base game selection process.

Therein, a description will be given, based on FIG. 12, of a sub-process of the base game selection process of the heretofore described S13. FIG. 12 is a flowchart of base game selection process programs in the slot machine 1 according to the embodiment. Each program shown hereafter in the flowchart in FIG. 12 is stored in the ROM 42 and RAM 43 included in the slot machine 1, and executed by the game controller 100.

First, as shown in FIG. 12, the game controller 100 carries out the selection of the symbols in S21. Specifically, by executing a random number generation program included in the selection program stored in the RAM 43, the game controller 100 selects a random number correlated to each of the three video reels 5L, 5C and 5R, from within the random number range “0 to 255”. Then, referring to the symbol weighting data corresponding to the payout ratio setting data, the game controller 100 determines the code number (refer to FIG. 3) of each video reel 5L, 5C and 5R, based on the three selected random numbers. After storing the determined code number of each video reel 5L, 5C and 5R in the RAM 43, the game controller 100 shifts to S21.

Herein, as the code numbers of the video reels 5L, 5C and 5R correspond to the code numbers of the symbols redisposed on the winning line L, by the game controller 100 determining the code number of each video reel 5L, 5C and 5R, the winning combination in the relevant game is determined. For example, in the event that the code numbers of the video reels 5L, 5C and 5R are determined to be “00”, “00” and “00”, it means that the game controller 100 has determined the winning combination to be “RED 7”. In this way, by determining the code number of each video reel 5L, 5C and 5R, the selection relating to the winning combinations (refer to FIG. 5) is carried out.

Furthermore, the game controller 100 carries out the selection of the scatter color in S22. Specifically, by executing the random number generation program included in the selection program stored in the RAM 43, the game controller 100 selects random numbers correlated one to each of the nine specific areas Z1 to Z9, from within the random number range “0 to 255”. Then, referring to the scatter color weighting data corresponding to the payout ratio setting data, the game controller 100 determines the color of the scatter color to be displayed in each of the nine specific areas Z1 to Z9 (including which color of scatter color is not to be displayed), based on the nine selected random numbers. After storing the determined details in the RAM 43, the game controller 100 returns to the heretofore described main game process of FIG. 11.

On returning to the heretofore described main game process of FIG. 11, the game controller 100 next, in S14, carries out a stop control process.

Therein, a description will be given, based on FIG. 13, of a sub-process of the stop control process of S14. FIG. 13 is a flowchart of stop control process programs in the slot machine 1 according to the embodiment. Each program shown hereafter in the flowchart in FIG. 13 is stored in the ROM 42 and RAM 43 included in the slot machine 1, and executed by the game controller 100.

Firstly, as shown in FIG. 13, the game controller 100 carries out the stopping of the symbols in S31. This process is a process which, after starting the revolving of all the video reels 5L, 5C and 5R, stops the revolving of each video reel 5L, 5C and 5R in such a way that the combination of symbols determined in the selection of the symbols (S21) of the base game selection process (S13) is redisposed on the winning line L. This process is a process carried out between the game controller 100 and the graphic board 68.

To explain specifically, first, the game controller 100 transmits a start signal to the graphic board 68 regarding the starting of the revolving of the video reels. The graphic board 68, on receiving the relevant start signal, carries out a video reel revolving display process. That is, the graphic board 68 carries out a display process starting the revolving condition of each video reel 5L, 5C and 5R on the lower image display panel 6.

Then, after the transmission of the start signal, the game controller 100 determines an effect aspect with respect to one game (aspects such as a display of an image on the upper image display panel 7 or a transmission of a sound from the speaker 28), and starts an effect with the determined effect pattern.

Subsequently, when a prescribed stop timing which stops the revolving condition of the video reels 5L, 5C and 5R comes along, the game controller 100 transmits the code numbers of the video reels stored in the RAM 43 to the graphic board 68. The graphic board 68, based on the code numbers of the video reels, executes a video reel stop display process. By this means, the symbols corresponding to the selection result of the heretofore described S21 are redisposed on the winning line L of the display windows 10L, 10C and 10R.

Furthermore, the game controller 100 carries out the texture mapping of the scatter color in S32. To explain specifically, the game controller 100, along with the determined details relating to the scatter color stored in the RAM 43 (those determined in the selection of the scatter color (S22) of the base game selection process (S13)), transmits a start signal to the graphic board 68 regarding the display of the scatter color. The graphic board 68, on receiving the relevant start signal, carries out a scatter color display process. That is, the graphic board 68, based on the details determined in the selection of the scatter color (S22) of the base game selection process (S13), displays the scatter color in one of the nine specific areas Z1 to Z9 on the lower image display panel 6.

Then, when displaying the scatter color in one of the specific areas Z1 to Z9, the graphic board 68 carries out the texture mapping which, while avoiding a surface of symbols redisposed in the specific areas Z1 to Z9 which are the display subjects of the scatter color, sticks the scatter color to a surface of the specific areas Z1 to Z9 which are the display subjects of the scatter color.

At this time, it is also acceptable, using the relevant texture mapping, to carry out a kind of effect which flash displays the scatter color behind the redisposed symbol in each specific area Z1 to Z9.

FIG. 1 shows an example of details displayed on the lower image display panel 6 when the texture mapping of the scatter color is carried out. In the example shown in FIG. 1, one color of scatter color is displayed behind the scatter symbol “ORANGE” in the specific area Z1.

Also, one color of scatter color is displayed behind the scatter symbol “APPLE” in the specific area Z8. In this way, depending on a result of the scatter color selection (S22) in the base game selection process (S13), the scatter color may also be displayed behind the symbols other than the scatter symbol.

Furthermore, the other color of scatter color is displayed behind the scatter symbol “ORANGE” in the specific areas Z3, Z6 and Z7.

Consequently, depending on the result of the scatter color selection (S22) in the base game selection process (S13), it may also happen that the scatter color is not displayed behind the symbol, as in the specific areas Z2, Z4, Z5, Z6 and Z9 shown in the example of FIG. 1.

Furthermore, depending on the result of the scatter color selection (S22) in the base game selection process (S13), it may happen that, even though the scatter symbol “ORANGE” is redisposed, the scatter color is not displayed behind the scatter symbol “ORANGE”, as in the specific area Z9 shown in the example of FIG. 1.

Subsequently, on returning to the heretofore described main game process of FIG. 11, the game controller 100 determines, in S15, whether or not a winning combination having a dividend has been established. As a result thereof, if any of the winning combinations shown in FIG. 5 has been established (S15: Yes), the game controller 100 shifts to S16. Contrarily, if no winning combination shown has been established (S15: No), the game controller 100 executes this program again.

In S16, the game controller 100 determines whether or not the bonus game trigger has been established during the base game. Specifically, when using the payout table of FIG. 5, it is determined that the bonus game trigger has been established in the event that the combination of “RED 7” symbols has been redisposed on the winning line L.

Then, if it is determined that the bonus game trigger has been established (S16: Yes), the game controller 100 executes a selection-type bonus game process in S17. Details of the bonus game process will be omitted. Subsequently, including a case in which it is determined that the bonus game trigger has not been established (S16: No), a payout process is carried out (S18).

Herein, a description will be given, based on FIG. 14, of a sub-process of the payout process of the heretofore described S18. FIG. 14 is a flowchart of payout process programs in the slot machine 1 according to the embodiment. Each program shown hereafter in the flowchart in FIG. 14 is stored in the ROM 42 and RAM 43 included in the slot machine 1, and executed by the game controller 100.

First, as shown in FIG. 14, the game controller 100 determines, in S41, whether or not the winning combination has been established in the base game. This determination is based on the code numbers of the video reels stored in the RAM 43. As a result thereof, if it determines that any winning combination shown in FIG. 5 has been established (S41: Yes), the game controller 100 proceeds to S42. In S42, the game controller 100, based on the payout table of FIG. 5, pays the player the dividend corresponding to the winning combination established in the base game, after which it proceeds to S43. Also, in the event too that the game controller 100 determines, in the heretofore described S41, that the winning combination has not been established in the base game (S41: No), it proceeds to S43.

In S43, the game controller 100 determines whether or not the scatter color has been displayed in the base game. This determination is based on the determination details relating to the scatter color stored in the RAM 43. Herein, if it is determined that the scatter color has been displayed in the base game (S43: Yes), proceeding to S44, the game controller 100 counts, separately for each color of scatter color, the number of the nine specific areas Z1 to Z9 in which the scatter color is displayed. Furthermore, the game controller 100, on proceeding to S45, limits the number counted to those in which “ORANGE”, which is the scatter symbol, has been redisposed.

Subsequently, the game controller 100, on proceeding to S46, pays the player, as a dividend corresponding to a scatter in the base game, based on the number limited in S45 and the payout table of FIG. 9, and proceeds to S47. Also, in the heretofore described S43, in the event too that it is determined that the scatter color has not been displayed in the base game (S43: No), the game controller 100 proceeds to S47.

In S47, the game controller 100 determines whether or not the bonus game has been started. This determination is based on the code numbers of the video reels stored in the RAM 43. As a result thereof, if it determines that the bonus game has been started (S47: Yes), the game controller 100, proceeding to S48, pays the player a dividend acquired in the bonus game. Subsequently, returning to the main game process of FIG. 11, the game controller 100 executes the relevant main game process again. Also, if it determines that the bonus game has not been started (S47: No), the game controller 100 returns to the main game process of FIG. 11, without paying the player a dividend for the bonus game, and executes the relevant main game process again.

As heretofore described in detail, in the slot machine 1 according to the embodiment, by simultaneously revolving and sequentially stopping the three video reels 5L, 5C and 5R, on each of which the plurality of symbols are depicted (S14, S31), and redisposing the plurality of symbols disposed in the display windows 10L, 10C and 10R of the lower image display panel 6, the base game which combines three symbols on the winning line L, which crosses the display windows 10L, 10C and 10R, is carried out. At this time, as shown in FIG. 1, it may happen that the scatter color is displayed in any of the specific areas Z1 to Z9 behind the redisposed symbols, regardless of whether or not it is on the winning line L. Then, in the event that “ORANGE”, which is the scatter symbol, is included among the redisposed symbols, the number of combinations in which the scatter color is displayed behind “ORANGE”, which is the scatter symbol, is counted (S44, S45). This count is carried out separately for each color of scatter color. Then, the dividend amount predetermined in accordance with the number counted is awarded to the player as the “any” dividend, based on the payout table of FIG. 9 (S46).

The invention not being limited to the heretofore described embodiment, various changes are possible without departing from its scope.

For example, it is also acceptable to carry out the “any” dividend based on the number of the specific areas Z1 to Z9 in which the scatter color is displayed. At this point, it is acceptable either to count the relevant number by color of scatter color, or to count regardless of color of scatter color. Furthermore, at this time, it is also acceptable to simultaneously carry out the “any” dividend based on the number of the scatter symbol “ORANGE” redisposed in the specific areas Z1 to Z9.

Also, in the stop control process of FIG. 11 (S14), unlike the flowchart shown in FIG. 13, it is also acceptable to simultaneously carry out the stopping of the symbols (S31) and the texture mapping of the scatter color (S32).

The invention is applicable to technology relating to the “any” dividend in the slot machine.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A slot machine comprising:
a display on which a plurality of symbols are disposed; and
a game controller which, as well as controlling the display, controls an implementation of a game, wherein
the game controller, every time it executes a redisposition of the plurality of symbols disposed on the display, decides whether or not to display a scatter color in any of specific areas positioned one behind each of the plurality of symbols redisposed on the display and, when displaying the scatter color in any of the specific areas of the display, in accordance with details of the decision, when executing the redisposition, counts a number of the specific areas of the display in which the scatter color has been displayed, and awards a prize based on the number counted.

2. The slot machine according to claim 1, wherein
the game controller limits a subject when counting the number of the specific areas of the display in which the scatter color has been displayed to specific areas of the display, among the specific areas of the display in which the scatter color has been displayed, in which a scatter symbol has been redisposed.

3. The slot machine according to claim 1, wherein
a plurality of kinds of scatter color being prepared,
the game controller counts the number of the specific areas of the display in which the scatter color has been displayed separately for each kind of scatter color.

4. The slot machine according to claim 1, wherein
the game controller displays the scatter color in the specific areas by means of a texture mapping which makes the specific areas of the display a textural surface and, with the display, excepts the symbols positioned inside the relevant display areas from the textural surface.

5. A slot machine comprising:
a display on which a plurality of symbols are disposed; and
a game controller which, as well as controlling the display, controls an implementation of a game, wherein the game controller:
every time it executes a redisposition of the plurality of symbols disposed on the display, decides whether or not to display a scatter color, a plurality of kinds of which have been prepared, in such a way as to include those colors, in any of specific areas positioned one behind each of the plurality of symbols redisposed on the display; and
when displaying the scatter color in any of the specific areas of the display, in accordance with details of the decision, when executing the redisposition, regarding counting a number of the specific areas of the display in which the scatter color has been displayed separately for each kind of scatter color, limits a subject when making the count to specific areas of the display, among the specific areas of the display in which the scatter color has been displayed, in which a scatter symbol has been redisposed, and awards a prize based on the number counted.

6. A slot machine comprising:
a display on which a plurality of symbols are disposed; and
a game controller which, as well as controlling the display, controls an implementation of a game, wherein the game controller:
every time it executes a redisposition of the plurality of symbols disposed on the display, decides whether or not to display a scatter color in any of specific areas positioned one behind each of the plurality of symbols redisposed on the display;
when displaying the scatter color in any of the specific areas of the display, in accordance with details of the decision, when executing the redisposition, displays the scatter color in the specific areas by means of a texture mapping which makes the specific areas of the display a textural surface; and
with the display, excepts the symbols positioned inside the relevant display areas from the textural surface and, regarding counting a number of the specific areas of the display in which the scatter color has been displayed, limits a subject when making the count to specific areas of the display, among the specific areas of the display in which the scatter color has been displayed, in which a scatter symbol has been redisposed, and awards a prize based on the number counted.

7. A slot machine comprising:
a display on which a plurality of symbols are disposed; and
a game controller which, as well as controlling the display, controls an implementation of a game, wherein the game controller:
every time it executes a redisposition of the plurality of symbols disposed on the display, decides whether or not to display a scatter color, a plurality of kinds of which have been prepared, in such a way as to include those colors, in any of specific areas positioned one behind each of the plurality of symbols redisposed on the display;
when displaying the scatter color in any of the specific areas of the display, in accordance with details of the decision, when executing the redisposition, displays the scatter color in the specific areas by means of a texture mapping which makes the specific areas of the display a textural surface; and
with the display, excepts the symbols positioned inside the relevant display areas from the textural surface, counts a number of the specific areas of the display in which the scatter color has been displayed separately for each kind of scatter color, and awards a prize based on the number counted.

8. A slot machine comprising:
a display on which a plurality of symbols are disposed; and
a game controller which, as well as controlling the display, controls an implementation of a game, wherein the game controller:
every time it executes a redisposition of the plurality of symbols disposed on the display, decides whether or not to display a scatter color, a plurality of kinds of which have been prepared, in such a way as to include those colors, in any of specific areas positioned one behind each of the plurality of symbols redisposed on the display;
when displaying the scatter color in any of the specific areas of the display, in accordance with details of the decision, when executing the redisposition, displays the scatter color in the specific areas by means of a texture mapping which makes the specific areas of the display a textural surface; and
with the display, excepts the symbols positioned inside the relevant display areas from the textural surface and, regarding counting a number of the specific areas of the display in which the scatter color has been displayed separately for each kind of scatter color, limits a subject when making the count to specific areas of the display, among the specific areas of the display in which the scatter color has been displayed, in which a scatter symbol has been redisposed, and awards a prize based on the number counted.

9. A slot machine playing method, wherein
a game controller repeats a unit game in which a redisposition of a plurality of symbols disposed on a display is performed, the method comprising:
a stage in which, every time the game controller executes the redisposition of the plurality of symbols disposed on the display, the game controller decides whether or not the game controller displays a scatter color in any of specific areas positioned one behind each of the plurality of symbols redisposed on the display;
a stage in which, when the game controller executes the redisposition, the game controller displays the scatter color in any of the specific areas of the display, in accordance with details of the decision;
a stage in which the game controller counts a number of the specific areas of the display in which the scatter color has been displayed; and
a stage in which the game controller awards a prize based on the number counted.

10. The slot machine playing method according to claim 9, further comprising:
a stage in which the game controller limits a subject when the game controller counts the number of the specific areas of the display in which the scatter color has been displayed to specific areas of the display, among the specific areas of the display in which the scatter color has been displayed, in which a scatter symbol has been redisposed.

11. The slot machine playing method according to claim 9, wherein
at the stage in which the game controller decides whether or not the game controller displays the scatter color in any of the specific areas positioned one behind each of the plurality of symbols redisposed on the display, the game controller decides whether or not the game controller displays the scatter color, a plurality of kinds of which have been prepared, in such a way as to include those colors, in any of the specific areas positioned one behind each of the plurality of symbols redisposed on the display, and
at the stage in which the game controller counts the number of the specific areas of the display in which the scatter color has been displayed, the game controller counts the number of the specific areas of the display in which the scatter color has been displayed separately for each kind of scatter color.

12. The slot machine playing method according to claim 9, wherein
at the stage at which the game controller displays the scatter color in any of the specific areas of the display, the game controller displays the scatter color in the specific areas by means of a texture mapping which makes the specific areas of the display a textural surface, and
with the display, the game controller excepts the symbols positioned inside the relevant display areas from the textural surface.

13. A slot machine playing method, wherein
a game controller repeats a unit game in which a redisposition of a plurality of symbols disposed on a display is performed, the method comprising:
a stage in which, every time the game controller executes the redisposition of the plurality of symbols disposed on the display, the game controller decides whether or not the game controller displays the scatter color, a plurality of kinds of which have been prepared, in such a way as to include those colors, in any of specific areas positioned one behind each of the plurality of symbols redisposed on the display;
a stage in which, when the game controller executes the redisposition, the game controller displays the scatter color in any of the specific areas of the display, in accordance with details of the decision;
a stage in which the game controller counts a number of the specific areas of the display in which the scatter color has been displayed separately for each kind of scatter color;
a stage in which the game controller limits a subject when making the count to specific areas of the display, among the specific areas of the display in which the scatter color has been displayed, in which a scatter symbol has been redisposed; and
a stage in which the game controller awards a prize based on the number counted.

14. A slot machine playing method, wherein
a game controller repeats a unit game in which a redisposition of a plurality of symbols disposed on a display is performed, the method comprising:
a stage in which, every time the game controller executes the redisposition of the plurality of symbols disposed on the display, the game controller decides whether or not the game controller displays a scatter color in any of specific areas positioned one behind each of the plurality of symbols redisposed on the display;
a stage in which, when the game controller executes the redisposition, regarding the game controller displaying the scatter color in any of the specific areas of the display, in accordance with details of the decision, the game controller displays the scatter color in the specific areas by means of a texture mapping which makes the specific areas of the display a textural surface and, with the display, the game controller excepts the symbols positioned inside the relevant display areas from the textural surface;
a stage in which the game controller counts a number of the specific areas of the display in which the scatter color has been displayed;
a stage in which the game controller limits a subject when making the count to specific areas of the display, among the specific areas of the display in which the scatter color has been displayed, in which a scatter symbol has been redisposed; and
a stage in which the game controller awards a prize based on the number counted.

15. A slot machine playing method, wherein
a game controller repeats a unit game in which a redisposition of a plurality of symbols disposed on a display is performed, the method comprising:
a stage in which, every time the game controller executes the redisposition of the plurality of symbols disposed on the display, the game controller decides whether or not the game controller displays the scatter color, a plurality of kinds of which have been prepared, in such a way as to include those colors, in any of specific areas positioned one behind each of the plurality of symbols redisposed on the display;
a stage in which, when the game controller executes the redisposition, regarding the game controller displaying the scatter color in any of the specific areas of the display, in accordance with details of the decision, the game controller displays the scatter color in the specific areas by means of a texture mapping which makes the specific areas of the display a textural surface and, with the display, the game controller excepts the symbols positioned inside the relevant display areas from the textural surface;
a stage in which the game controller counts a number of the specific areas of the display in which the scatter color has been displayed separately for each kind of scatter color; and
a stage in which the game controller awards a prize based on the number counted.

16. A slot machine playing method, wherein
a game controller repeats a unit game in which a redisposition of a plurality of symbols disposed on a display is performed, the method comprising:
a stage in which, every time the game controller executes the redisposition of the plurality of symbols disposed on the display, the game controller decides whether or not the game controller displays the scatter color, a plurality of kinds of which have been prepared, in such a way as to include those colors, in any of specific areas positioned one behind each of the plurality of symbols redisposed on the display;
a stage in which, when the game controller executes the redisposition, regarding the game controller displaying the scatter color in any of the specific areas of the display, in accordance with details of the decision, the game controller displays the scatter color in the specific areas by means of a texture mapping which makes the specific areas of the display a textural surface and, with the display, the game controller excepts the symbols positioned inside the relevant display areas from the textural surface;
a stage in which the game controller counts a number of the specific areas of the display in which the scatter color has been displayed separately for each kind of scatter color;
a stage in which the game controller limits a subject when making the count to specific areas of the display, among the specific areas of the display in which the scatter color has been displayed, in which a scatter symbol has been redisposed; and
a stage in which the game controller awards a prize based on the number counted.
